(19) United States
(12) Patent Application Publication
(10) Pub. No.: US 2005/0166357 A1
(43) Pub. Date: Aug. 4, 2005

(54) Self-propelling cleaner

(75) Inventor: Naoya Uehigashi, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/047,279

(22) Filed: Jan. 31, 2005

(30) Foreign Application Priority Data
Jan. 30, 2004 (JP) JP2004-024513

(51) Int. Cl. A47L 5/00; E01H 1/08

(52) U.S. Cl. 15/319

(57) ABSTRACT

When an object collides with a main body 1 during a cleaning and propelling operation, an acceleration sensor 11 obtains acceleration information according to the movement of the main body 1 due to the collision unlike the normal cleaning and propelling operation state. The control unit 10 detects based on the acceleration information that the main body 1 has collided with the object and controls motors 8 to rotate the main body 1 at that position by one revolution. A non-contact type sensor 12 detects the peripheral state of the main body and supplies the detected information to the control unit 10. When the control unit 10 determines based on the detected information that there is a new obstacle, the control unit reflects the obstacle on mapping data stored in a memory 13 and corrects a propelling route so as to avoid the obstacle.

### BACKGROUND OF THE INVENTION

1. Field of the Invention

The present invention relates to a self-propelling cleaner which performs cleaning while automatically propels on a propelling route stored in advance and, in particular, relates to a restoring processing just after an obstacle collides with the cleaner while the cleaning and propelling operation.

2. Description of the Related Art

Conventionally, a self-propelling cleaner includes a cleaning unit having a nozzle for sucking dust on a floor, a brush for striking up dust on the floor, a dust chamber for accommodating dust thus sucked and a sweeping fan for introducing dust within the dust chamber, and a propelling unit having propelling wheels and a motor for driving the propelling wheels. The self-propelling cleaner cleans the floor by controlling the cleaning unit while propelling a main body thereof along a propelling route stored in advance within a designated cleaning region by controlling the propelling unit.

Such a self-propelling cleaner is provided at the main body with a non-contact type sensor such as an infrared ray sensor. The self-propelling cleaner calculates a propelling route and propels while the non-contact type sensor detects obstacles and target objects thereby to propel without colliding with the obstacles existing within the cleaning region (see JP-A-2002-328724 and JP-A-8-266454, for example).

### SUMMARY OF THE INVENTION

However, according to the aforesaid conventional self-propelling cleaner, it is difficult to detect an object (obstacle) and avoid the collision with the object when the object moves toward the main body (for example, a case such as a ball hits the main body) while the propelling operation. Thus, when an object moves toward the main body, usually the object collides with the main body. Then, the object thus collided rebounds off the main body and may stop around the main body. In this case, the object thus collided with the main body remains as a new obstacle within the cleaning region. When this object exists quite near the main body, there arises a problem that the propelling operation is restarted in a state that the current circumstance near the main body just after the collision can not be detected accurately and so the main body collides with the object again.

One of objects of the invention is to provide a self-propelling cleaner which can, even just after colliding with an object unexpectedly during a cleaning and propelling operation, restart the cleaning propelling without contacting again with the object thus collided.

According to a first aspect of the invention, there is provided a self-propelling cleaner including: a main body; a cleaning unit that collects and accommodates dust; a propelling unit that propels the main body; a controller that controls the cleaning unit and the propelling unit to perform cleaning while propelling the main body along a propelling route set in advance; a collision detector that detects collision of the main body to an object and detects movement of the main body; and a periphery detector that is provided at a front portion of the main body and detects external circumstance of the main body, wherein the controller controls, when the collision detector detects the collision, the propelling unit to rotate the main body to detect circumstance around the main body by the periphery detector and corrects the propelling route.

According to a second aspect of the invention, there is provided a self-propelling cleaner including: a main body; a cleaning unit that collects and accommodates dust; a propelling unit that propels the main body; a controller that controls the cleaning unit and the propelling unit to perform cleaning while propelling the main body along a propelling route set in advance; a collision detector that detects collision of the main body to an object; and a periphery detector that detects external circumstance of the main body, wherein the controller controls, when the collision detector detects the collision, the propelling unit to rotate the main body to detect circumstance around the main body by the periphery detector and corrects the propelling route.

### BRIEF DESCRIPTION OF THE DRAWINGS

The above objects and advantages of the present invention will become more apparent by describing preferred exemplary embodiments thereof in detail with reference to the accompanying drawings, wherein:

FIG. 1 is a diagram showing the schematic configuration of a self-propelling cleaner according to an embodiment of the invention; and

FIGS. 2A-2C are diagrams showing mapping data and propelling routes stored in a memory 13.

### DETAILED DESCRIPTION OF THE PREFERRED EMBODIMENTS

A self-propelling cleaner according to an embodiment of the invention will be explained with reference to drawings.

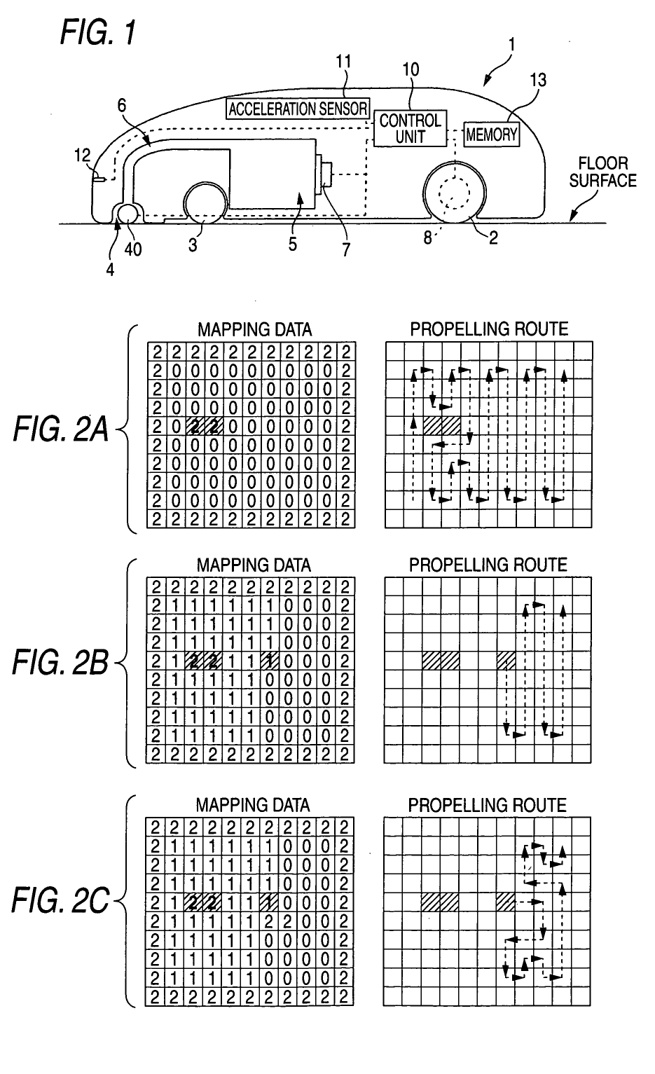

FIG. 1 is a diagram showing the schematic configuration of the self-propelling cleaner according to the embodiment.

As shown in FIG. 1, driving wheels 2 are provided at the left and right portions of the lower portion at the rear side of the main body 1 of the self-propelling cleaner, respectively. Driving motors 8 are coupled to the driving wheels 2, respectively, and are electrically coupled to a control unit 10. The control unit 10 separately sends control instructions to the motors 8, respectively, thereby to independently rotate the driving wheels 2. The motors 8 are provided within the driving wheels 2, respectively. Each of the driving wheels 2 is configured to be able to be directed to any direction of 360 degrees (omnirange) and rotate. A driven wheel 3 is provided at the almost center portion of the lower portion at the front side of the main body 1. According to such a configuration, when the driving wheels 2 are rotated with the same rotation speed in the same direction, the main body 1 propels in this direction. In contrast, the main body 1 circles when the rotation speeds of the driving wheels are adjusted so as to differ to each other, whilst the main body 1 rotates at the same position when the rotational directions of the driving wheels 2 are made opposite to each other. In this respect, the driving wheels 2, the driving motor 8 and the driven wheel 3 correspond to “a propelling unit” according to the invention.

The main body 1 is provided at the lower portion of the front side thereof with a nozzle 4 for removing dust from a floor, a box-shaped dust chamber 5 for accommodating dust therein, and a dust transporting pipe 6 for coupling the nozzle 4 to the dust chamber 5 to conduct dust into the dust chamber 5. A cylindrical brush 40 is disposed within the nozzle 4. A sweeping fan 7 is provided on the side wall of the dust chamber 5 on the side thereof opposing to the dust transporting pipe 6. The sweeping fan 7 and the brush 40 are electrically coupled to the control unit 10. The nozzle 4, the brush 40, the dust chamber 5, the dust transporting pipe 6 and the sweeping fan 7 correspond to “a cleaning unit” according to the invention.

An acceleration sensor 11 is fixed to the main body 1. Acceleration information observed by the acceleration sensor 11 is outputted to the control unit 10. Further, a non-contact type sensor 12 such as an infrared ray sensor is disposed at the front end portion of the main body 1. The non-contact type sensor 12 irradiates an infrared ray within a predetermined range and receives a reflection ray thereof to detect an obstacle at the forward portion of the main body 1. The non-contact type sensor 12 is electrically coupled to the control unit 10, whereby a detection signal from the non-contact type sensor 12 is inputted into the control unit 10. In the embodiment, the non-contact type sensor 12 corresponds to “a periphery detector” according to the invention, and the acceleration sensor 11 corresponds to “a collision detector” according to the invention.

The main body 1 is provided with the control unit 10 for controlling the entire operation of the self-propelling cleaner. The control unit 10 is provided with a memory 13 which stores therein mapping data as shown in FIG. 2 in which status of the cleaning region is mapped.

FIGS. 2A-2C are diagrams representing the mapping data (figures in the left column) showing the status of the cleaning region stored in the memory 13 and propelling routes (figures in the right column). In each of these figures, each block represents an area of a predetermined size obtained by dividing the cleaning region in a lattice pattern. A numeral shown in each of the blocks or areas in the figures of the left column represents the state of the block. In this case, “0” represents a non-cleaned area, “1” represents a cleaned area, and “2” represents an area in which an obstacle exists. In the figures of the right column, each of dotted arrow lines bent in a zigzag manner represents a propelling route of the main body. In these figures, FIG. 2A represents initial mapping data before starting the cleaning, FIG. 2B represents mapping data in a state where an object collides with the main body during the cleaning, and FIG. 2C represents mapping data in a state after the object collides with the main body and then circumstance near the main body is detected.

Then, the control unit 10 controls the respective portions within the main body 1 so as to perform the cleaning while propelling along a propelling route set based on the mapping data within the cleaning region stored in the memory 13 in advance.

Next, the operation of the self-propelling cleaner according to the invention will be explained.

The memory 13 stores in advance states of the respective areas (blocks) partitioned within the cleaning region as the mapping data (FIG. 2A). In this case, the respective data “2” at the outermost portions each representing that an obstacle exists there designate the cleaning region. The control unit 10 calculates, based on the mapping data stored in the memory, a propelling route as shown by the dotted arrow line in FIG. 2A which starts from one corner of the cleaning region, terminates at a corner opposing to the one corner and avoids obstacles within the cleaning region, and stores the propelling route thus calculated in the memory 13. This propelling route is configured based on a so-called “zigzag propelling route” so as to propel the main body along a predetermined edge (the side edge in the figure) from the one corner (the left bottom portion in the figure) serving as the start point, then make a right-angle turn (in the direction along the upper and lower side edges in the figure) when the main body reaches the end portion of the cleaning region (the left uppermost portion in the figure), then make a right-angle turn again (in the direction along the side edge in the figure) when the main body propels a predetermined distance, and then propel in the direction opposite to that in the previous propelling along the side edge. In this case, the propelling route is set, when there is an obstacle on the way of the propelling route, so as to avoid the obstacle but to set the route as short as possible.

When a user inputs a cleaning start instruction or the control unit detects a cleaning start time, the control unit 10 controls the driving motors 8 so as to propel the main body 1 along the aforesaid propelling route. Since the driving motors 8 rotate the driving wheels 2 in accordance with the control instruction from the control unit, the main body 1 propels along the aforesaid propelling route. In this case, the control unit 10 calculates the propelling speed and the propelling direction of the main body in accordance with acceleration information inputted from the acceleration sensor 11 thereby to control the driving motor 8 so as to propel the main body 1 at a speed and in a direction both set in advance.

Simultaneously, the control unit 10 drives the brush 40 and the sweeping fan 7. Thus, the brush 40 rotates and strikes dust on the floor up thereby to take the dust into the nozzle 4. Further, the sweeping fan 7 generates wind to carry the dust through the dust transporting pipe 6 thereby to introduce the dust within the dust chamber 5. When the control unit 10 detects based on the calculation result of the propelling distance and the propelling direction that the cleaning of the mapped single area is completed, the control unit updates the data “0” of this single area representing the non-cleaned area to “1” representing the cleaned area and stores this updated data into the memory 13 (FIG. 2B).

Next, when an object (obstacle) from the outside collides with the main body 1 during the propelling and cleaning operation, the main body 1 changes its propelling operation in response to the collision. Since the acceleration sensor 11 observes and outputs the acceleration information according to the propelling operation of the main body 1, when the main body 1 collides with an object and abruptly changes its propelling operation, the acceleration sensor obtains acceleration information according to the change. The control unit 10 inputs this acceleration information and calculates the propelling speed and the propelling direction of the main body 1 in accordance with the acceleration information. If the propelling speed and the propelling direction thus calculated differ from a propelling speed and a propelling direction at the time of the normal cleaning and propelling operation set in advance, it is determined that an object has collided with the main body and so both the propelling operation and the cleaning operation are stopped. Since the acceleration sensor 11 can also detect the collision with an object, the acceleration sensor 11 corresponds to the “collision detector” of the invention. Further, the control unit 10 calculates a position where the main body stopped by using the acceleration information obtained from the acceleration sensor 11 and updates the mapping data.

In this time point, the mapping data stored in the memory 13 is shown in FIG. 2B, in which the propelling route of the non-cleaned areas is the same as that of the initial state shown in FIG. 2A.

Next, when it is detected that an object has collided with the main body, the control unit 10 drives the respective motors 8 thereby to control the main body 1 so as to rotate at this position by 360 degrees. That is, the respective motors 8 rotate the corresponding driving wheels 2 in different directions in accordance with the respective control instructions thereby to rotate the main body 1 at this position by 360 degrees (omnirange). At this time, the non-contact type sensor 12 irradiates an infrared ray. When the object thus collided with the main body exists near the main body 1, the infrared ray is reflected by the main body. Thus, the non-contact type sensor 12 receives the reflection ray and outputs a detection signal according to the intensity of the received ray to the control unit 10. The control unit 10 receives and stores the detection signal over 360 degrees (omnirange) thereby to detect the position of the object (obstacle) at the periphery of the main body 1. Then, the control unit changes the data at the area where the object is detected to exist from “0” representing the non-cleaned area to “2” representing an area in which the obstacle exists thereby to update the mapping data stored in the memory 13 (FIG. 2C). Further, the control unit calculates a new propelling route based on the mapping data thus updated and updates the propelling route stored in the memory 13. In this case, the control unit calculates the new propelling route as shown in FIG. 2C with reference to the aforesaid basic propelling route so as to avoid the new obstacle and sequentially couple the non-cleaned areas. Incidentally, the new propelling route is not limited to this example and may be any route which is arranged to pass the entire areas expect for the area(s) where an obstacle(s) exists.

Next, the control unit 10 performs the control to restart the propelling and cleaning operation based on the propelling route thus corrected. When it is detected that the cleaner has propelled and cleaned all the areas where no obstacle exists within the cleaning region set in advance, the cleaning and propelling operation is terminated.

Since the cleaner is configured in the aforesaid manner, even just after an object collides with the main body unexpectedly during the propelling and cleaning operation, the position of the object thus collided can be detected and the propelling and cleaning operation can be restarted in accordance with a new propelling route which avoids the object. Thus, the self-propelling cleaner which can perform the cleaning operation while propelling efficiently and effectively can be configured.

Although the aforesaid embodiment employs the non-contact type sensor utilizing an infrared ray, the invention can realize the aforesaid configuration and attain the aforesaid effects even when another non-contact type sensor is employed.

As described with reference to the embodiment, according to one aspect of the invention, there is provided a self-propelling cleaner including: a main body; a cleaning unit that collects and accommodates dust; a propelling unit that propels the main body; a controller that controls the cleaning unit and the propelling unit to perform cleaning while propelling the main body along a propelling route set in advance; a collision detector that detects collision of the main body to an object; and a periphery detector that detects external circumstance of the main body, wherein the controller controls, when the collision detector detects the collision, the propelling unit to rotate the main body to detect circumstance around the main body by the periphery detector and corrects the propelling route.

According to this configuration, when an object collides with the main body from the outside, the collision detector detects the direction to which the object collided and the magnitude of the impact. The controller detects through the propelling unit based on the detection result whether or not the object exists near the main body. When the object thus collided exists at the periphery of the main body, the controller detects this object as a new obstacle and corrects a propelling route set in advance so that the main body does not to contact with the new obstacle. The controller restarts the cleaning and propelling operation by using the propelling unit in accordance with the new propelling route.

In the self-propelling cleaner, the periphery detector may be provided only at the front portion of the main body.

According to this configuration, when the main body collides with the object, the main body rotates as described above. In this case, the detection result corresponding to one revolution of the main body obtained from the periphery detector provided at the front portion of the main body is stored, whereby the circumstance of the omnirange at the periphery of the main body can be detected.

In the self-propelling cleaner, the collision detector may further detect movement of the main body.

According to this configuration, when the main body collides with the object, a force due to the collision of the object is applied to the main body, the main body performs a propelling operation different from the normal cleaning and propelling operation such that the propelling speed is made slow suddenly. The collision detector detects the change of the propelling operation thereby to detect the collision. The main body is also controlled in its propelling operation at the time of the normal cleaning operation, the collision detector can detect the movement of the main body in this propelling control state.

According to the embodiment, when an object collides with the main body, it is possible to detect at which position in the periphery of the main body the object exists after the collision. Thus, this object is detected as a new obstacle existing within a cleaning region and hence the propelling route stored in advance can be corrected into a new propelling route which avoids this obstacle. Thus, when the propelling operation is restarted after the collision, the main body can be propelled without colliding with this obstacle again.

Further, according to the embodiment, as described above, the circumstance of the omnirange at the periphery of the main body can be detected by merely disposing the periphery detector at the front portion of the main body. Thus, it is not necessary to dispose the periphery detector in the omnirange direction. Therefore, the self-propelling cleaner can be realized with a simple configuration that can restart the cleaning and propelling operation without colliding with the obstacle again as described above after the collision with the obstacle.

Further, according to the embodiment, since the collision detector can detect the movement of the main body, it is not necessary to separately provide means for detecting the movement of the main body. Thus, as described above, the self-propelling cleaner can be realized with a further simple configuration that can restart the cleaning and propelling operation without colliding with the obstacle again after the collision with the obstacle.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

1. A self-propelling cleaner comprising:
a main body;
a cleaning unit that collects and accommodates dust;
a propelling unit that propels the main body;
a controller that controls the cleaning unit and the propelling unit to perform cleaning while propelling the main body along a propelling route set in advance;
a collision detector that detects collision of the main body to an object and detects movement of the main body; and
a periphery detector that is provided at a front portion of the main body and detects external circumstance of the main body,
wherein the controller controls, when the collision detector detects the collision, the propelling unit to rotate the main body to detect circumstance around the main body by the periphery detector and corrects the propelling route.

2. A self-propelling cleaner comprising:
a main body;
a cleaning unit that collects and accommodates dust;
a propelling unit that propels the main body;
a controller that controls the cleaning unit and the propelling unit to perform cleaning while propelling the main body along a propelling route set in advance;
a collision detector that detects collision of the main body to an object; and
a periphery detector that detects external circumstance of the main body,
wherein the controller controls, when the collision detector detects the collision, the propelling unit to rotate the main body to detect circumstance around the main body by the periphery detector and corrects the propelling route.

3. The self-propelling cleaner according to claim 2, wherein the periphery detector is provided only at a front portion of the main body.

4. The self-propelling cleaner according to claim 2, wherein the collision detector detects movement of the main body.

5. The self-propelling cleaner according to claim 2, wherein the collision detector includes an acceleration sensor.

6. The self-propelling cleaner according to claim 2, wherein the periphery detector includes a non-contact type sensor.
